(19) United States
(12) Patent Application Publication
(10) Pub. No.: US 2017/0097967 A1
(43) Pub. Date: Apr. 6, 2017

(54) Automated Customization of Display Component Data for Search Results

(71) Applicant: Quixey, Inc., Mountain View, CA (US)

(72) Inventors: Taher SAVLIWALA, Mountain View, CA (US); Jonathan BEN-TZUR, Sunnyvale, CA (US)

(21) Appl. No.: 15/286,550

(22) Filed: Oct. 5, 2016

Related U.S. Application Data
(60) Provisional application No. 62/237,309, filed on Oct. 5, 2015.

(51) Int. Cl. G06F 17/30

(52) U.S. Cl. CPC G06F 17/30554; G06F 17/30864; G06F 17/30253; G06F 17/30256; G06F 17/3053; G06F 17/30268

(57) ABSTRACT

A method includes storing search records in a data store located in memory hardware and receiving, at data processing hardware in communication with the memory hardware, a search query from a user device. The method includes selecting search records from the data store based on the search query. The method includes, for a first search record, selecting one image for a first search result from a plurality of images associated with the first search record based on relevance of metadata for the one image to the search query. The first search result includes a first user-selectable link and a first access mechanism. The first user-selectable link invokes the first access mechanism in response to being actuated by a user. The first access mechanism launches a corresponding mobile application to a corresponding state. The method includes transmitting the search results from the data processing hardware to the user device.

### CROSS-REFERENCE TO RELATED APPLICATIONS

This application claims the benefit of U.S. Provisional Application No. 62/237,309, filed on Oct. 5, 2015. The entire disclosure of the application referenced above is incorporated by reference.

### FIELD

This disclosure relates to customizing display component data, such as icon images, for entity search.

### BACKGROUND

In recent years, use of computers, smartphones, and other Internet-connected devices has grown exponentially. Correspondingly, the number of available software applications (or, “apps”) for such devices has also grown. Today, many diverse native and web software applications can be accessed on any number of different devices, including smartphones, personal computers, automobiles, and televisions. These diverse applications can range from business driven applications, games, educational applications, news applications, shopping applications, messaging applications, media streaming applications, social networking applications, and so much more. Furthermore, application developers develop vast amounts of applications within each genre, and each application may have numerous editions.

In addition, information available on the internet has grown exponentially, which may make it difficult for a user to find specific information he/she is researching. Even when presented with potentially relevant results, it is difficult for a user to identify which results are most responsive to their query or which results are worth exploring further.

### SUMMARY

A method includes storing search records in a data store located in memory hardware. Each search record of the search records includes an access mechanism associated with a state of a mobile application. The method includes receiving, at data processing hardware in communication with the memory hardware, a search query from a user device. The method includes selecting, by the data processing hardware, a set of search records from the data store based on the search query. The method includes generating search results corresponding to the set of search records. The method includes, for a first search record of the set of search records, (i) selecting one image from a plurality of images associated with the first search record based on relevance of metadata for the one image to the search query and (ii) including the one image in a first search result of the search results for display on the user device. The first search result includes a first user-selectable link and a first access mechanism. The first user-selectable link is configured to invoke the first access mechanism in response to being actuated by a user of the user device. The first access mechanism is configured to, upon invocation, launch a corresponding mobile application to a corresponding state. The method includes transmitting the search results from the data processing hardware to the user device.

In other features, the corresponding mobile application for the first access mechanism is a website edition of a first application. The corresponding state for the first access mechanism is a web page of the website edition. In other features, the first search record includes a second access mechanism configured to, upon invocation, open a native edition of the first application to a corresponding screen of the native edition. In other features, the corresponding mobile application for the first access mechanism is a native edition of a first application. the corresponding state for the first access mechanism is a screen of the native edition.

In other features, the method includes generating the metadata for the plurality of images associated with the first search record. In other features, the generating the metadata for the plurality of images associated with the first search record includes analyzing text associated with the plurality of images. In other features, the generating the metadata for the plurality of images associated with the first search record includes performing image recognition on the plurality of images. In other features, the generating the metadata for the plurality of images associated with the first search record is performed in response to the first search record being selected by the data processing hardware. In other features, the generating the metadata for the plurality of images associated with the first search record is performed prior to receiving the search query.

In other features, the search query includes a text query and context data. The context data includes geolocation data of the user device. In other features, selecting the one image includes determining a candidate image from the plurality of images based on a best textual match between metadata for the candidate image and the search query; calculating a confidence score for the candidate image indicative of a level of relevance of the metadata for the candidate image to the search query; in response to the confidence score exceeding a threshold confidence score, selecting the candidate image as the one image; and in response to the confidence score failing to exceed the threshold confidence score, selecting a default image of the plurality of images as the one image.

In other features, selecting the one image includes determining a candidate image from the plurality of images based on a best textual match between metadata for the candidate image and the search query; calculating a popularity score for the candidate image indicative of a level of popularity of the candidate image among end users based on at least one of (i) user ratings and (ii) click-through rate for the candidate image; in response to the popularity score exceeding a threshold popularity score, selecting the candidate image as the one image; in response to the popularity score failing to exceed the threshold popularity score, selecting a default image of the plurality of images as the one image.

A search system includes memory hardware configured to store (i) a set of instructions and (ii) a data store of search records. Each search record of the search records includes an access mechanism associated with a state of a mobile application. The search system includes processing hardware electrically coupled to the memory hardware and configured to execute the set of instructions. The set of instructions includes storing search records in a data store located in memory hardware. Each search record of the search records includes an access mechanism associated with a state of a mobile application. The set of instructions includes receiving, at data processing hardware in communication with the memory hardware, a search query from a user device. The set of instructions includes selecting, by the data processing hardware, a set of search records from the data store based on the search query. The set of instructions includes generating search results corresponding to the set of search records. The set of instructions includes, for a first search record of the set of search records, (i) selecting one image from a plurality of images associated with the first search record based on relevance of metadata for the one image to the search query and (ii) including the one image in a first search result of the search results for display on the user device. The first search result includes a first user-selectable link and a first access mechanism. The first user-selectable link is configured to invoke the first access mechanism in response to being actuated by a user of the user device. The first access mechanism is configured to, upon invocation, launch a corresponding mobile application to a corresponding state. The set of instructions includes transmitting the search results from the data processing hardware to the user device.

A method includes receiving, at data processing hardware, a search query from a user device. The method includes obtaining, by the data processing hardware, search records from memory hardware in communication with the data processing hardware. The method includes, for at least one search record, (i) obtaining, by the data processing hardware, display component data from the memory hardware based on the search query and metadata associated with the display component data, the display component data corresponding to at least one renderable display component and (ii) associating the display component data with the at least one search record. The method includes transmitting the search records from the data processing hardware to the user device, each search record includes an access mechanism, the access mechanism, when executed by the user device, causes the user device to access a resource identified by the access mechanism.

In other features, the display component data includes an image or review data. In other features, the display component data, when rendered by the user device, causes the user device to render one or more display components corresponding the display component data, at least one display component functioning as a user selectable link associated with the access mechanism. In other features, the search records include an entity record and/or an application state record, the application state record includes the access mechanism. In other features, the method includes receiving, at the data processing hardware, a query wrapper includes the search query and a geo-location of the user device. Obtaining the search records is based on the query wrapper.

In other features, obtaining the display component data includes comparing the search query and the metadata associated with the display component data and obtaining the display component data having metadata that at least partially matching the search query. In other features, associating the display component data with the at least one search record includes determining a confidence score for the display component data, the confidence score indicative of a level of relevance of the metadata of the display component data to the search query. When the confidence score satisfies a threshold confidence score, associating the display component data with the at least one search record. When the confidence score fails to satisfy the threshold confidence score, associating default display data with the at least one search record.

In other features, the method includes determining a popularity score for the display component data, the popularity score indicative of a level of popularity of the display component data among users, based on user ratings. When the confidence score satisfies the threshold confidence score and the popularity score satisfies a threshold popularity score, associating the display component data with the at least one search record. When the confidence score fails to satisfy the threshold confidence score or the popularity score dissatisfies the threshold popularity score, associating the default display component data with the at least one search record. In other features, the method includes associating a result score with each search record, the result score based on the confidence score and/or the popularity score. In other features, the application access mechanism has a reference to an application and indicates a performable operation for the application.

A method includes receiving, at data processing hardware of a user device, a search query. The method includes transmitting the search query from the data processing hardware to a search system. The method includes receiving, at the data processing hardware, search results from the search system, in response to the transmitted search query. The method includes rendering, by the data processing hardware, the search results on a screen of the user device. The search results includes result objects. Each result object includes (i) display component data having metadata corresponding to the search query and (ii) at least one access mechanism that, when executed by the user device, causes the user device to access a resource identified by the access mechanism.

In other features, each rendered result object is a single user-selectable link associated with the at least one access mechanism. In other features, the method includes receiving, at the data processing hardware, a selection of a rendered result object; launching, by the data processing hardware, an application associated with the access mechanism of the rendered result object; and setting, by the data processing hardware, the application to a state indicated by the access mechanism. In other features, the rendered result object includes one or more display components corresponding to the display component data, each display component being a user-selectable link associated with a corresponding access mechanism. In other features, each display component has an associated access mechanism different from any other access mechanism of any other display component of the result object.

In various features, some or all of the above method elements can be implemented as instructions stored on a non-transitory computer-readable medium.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

FIG. 1A is a schematic view of an exemplary environment including a user device and a search system.

FIG. 1B is a functional block diagram of an example system having a search system that interacts with the user device and one or more application systems.

FIG. 2A is a schematic view of an exemplary user device in communication with the search system.

FIG. 2B is a schematic view of an example user device.

FIGS. 3A and 3B are functional block diagrams of example search systems.

FIGS. 3C-3F are schematic views of example application state records.

FIGS. 4A and 4B are schematic views of example entity records.

FIG. 5 is an example arrangement of operations for selecting display component data and generating search results based on a received search query.

FIG. 6A is a schematic view of an example user device displaying an exemplary graphical user interface displaying search results.

FIG. 6B is a schematic view of an example user device displaying an example application launched to a certain state.

FIG. 6C is a schematic view of an example user device displaying an example application launched to an alternate state.

FIGS. 7A and 7B are schematic views of an example user device displaying exemplary graphical user interfaces displaying search results.

FIG. 7C is a schematic view of an example user device displaying an example application launched to a certain state.

FIG. 8 is an example arrangement of operations for selecting images and generating displayed search results based on the selected images.

FIG. 9 is an example arrangement of operations for querying a search system and displaying search results on a screen of a user device.

FIG. 10 is a schematic view of an example computing device executing any systems or methods described herein.

Like reference symbols in the various drawings indicate like elements.

### DETAILED DESCRIPTION

The present disclosure describes adjusting how search results are displayed to a user based on a search query and/or user context by adjusting display components (e.g., images) in search results (e.g., user-selectable links) on a search engine results page (SERP). A search system may receive a search query and identify a set of search results relevant to the search query. The search system or a separate rendering system can then select display component data (e.g., image data and/or user review data) for display in the search results on the SERP.

The search results are selected by the search system from a repository (such as a database) of search records. Each search record may reference a certain state (or, screen) of an app and/or a certain web URL (uniform resource locator). Each search record may include one or more access mechanisms that allow the user device to reach the certain state or URL corresponding to the search record. Some or all search records include metadata that allows the search system to determine whether the search record is relevant to a search query. This metadata may also be used to visually represent a search result to a user. Each search record may additionally include metadata that is used for displaying the search result but not for use by the search system in determining whether the search record is relevant to a query.

Once the search system identifies a set of relevant results from the search records, metadata from each search record may be sent to the user device in order to display the search record as a search result. This display component data may be derived from metadata of the search record, regardless of whether that metadata was used by the search system in selecting the search record as a relevant result and regardless even of whether the metadata could have been used by the search system in selecting the search record as a relevant result.

For example, search records may include images that are not indexed by the search system for purposes of selection. However, once a search result is chosen, the search system may use information related to the image to determine which image or images should accompany the search result.

In some implementations, more data (including images and text) than is usually displayed can be sent to the user device. The user device may be responsible for selecting some subset of the data, such as based on a resolution of the device and screen real estate dedicated to search results. In other words, the search system may identify a search record as being relevant to a query, select three images from eight images in the search record, and provide those three images to the user device. The user device may then, based on a limited amount of screen real estate, select only one of the images (such as the first-transmitted image) for display to the user.

The search system may select an image from a search record based on metadata related to the image. For example, the metadata may include a caption associated with the image. In one example, a restaurant review app invites users of the restaurant review app to upload pictures from restaurants and supply associated textual captions. This caption text may be used by the search system to select one or more relevant images from within a search record.

In some implementations, the metadata associated with the image may also be used by the search system to identify relevant search records. Further, metadata from an image may be used to identify the search record as relevant even if that image itself is not later selected by the search system for displaying the corresponding search result.

In various implementations, the search system may evaluate an image and tag that image with certain metadata. For example, the search system may use an image recognition subsystem to identify the objects present in the image. The search system may also analyze text corresponding to the image to identify text that is most relevant to the image. Continuing the restaurant review app example, an image may be associated with a text review. The review text may be parsed using natural language processing to attempt to determine which words or phrases most closely correspond (spatially or grammatically) to the image. For example, a review may discuss a particular food item in close spatial proximity to the text “picture of.”

Processing images and other data to extract metadata for the image may be performed in an offline mode, as contrasted with online analysis. Online analysis means that the search system performs processing to obtain image metadata for a search record once the search record is determined to be relevant. This image processing may then be cached for next time that the search record is determined to be relevant.

In short, the search system selects display component data deemed to be of most interest to the user when conveying search results to the user device. Continuing the restaurant example, if a user searches for a particular menu item, results from various restaurant review apps corresponding to restaurants that serve that menu item will likely be relevant to the user. In obtaining these search results, the search system may analyze metadata associated with the search records, including metadata associated with images. However, results are typically presented with an image specific to the app as opposed to an image corresponding to why the result is relevant to the query.

In other words, when looking for a restaurant that serves Pad Thai, a user may see images of the apps that have results for Pad Thai and may even see images of the default images of the restaurants, such as pictures of the edifices of the restaurants. The present disclosure describes returning search results to users that include pictures, if available, of Pad Thai at those particular restaurants in the search results. This may allow a user to more quickly take action on a search result (such as booking a table or traveling to the restaurant) and/or may allow a user to determine which search results should be investigated further, such as by accessing the corresponding state of the app referenced by the search results.

In some implementations, display component data, such as images, may not be stored in the search records. Instead, the search system may attempt to find relevant images once the search results are determined. For example, if a first state of a first app is determined to be a relevant search result, the search system may access the first state of the first app in a back-end system and attempt to acquire display component data, such as relevant images, directly from the first app for provision to the user. In addition to decreasing the storage space needed, this may allow for the freshest and most up-to-date display component data. When display component data is obtained for a search record, that display component data may be cached for a certain period of time. That period of time may be set based on the type of app and may be adjusted based on historical observations of how often display component data changes for certain apps or classes of apps.

In other implementations, including some described below, the search system may search for display component data for search results from resources not specific to those search results. In other words, if a first search record is determined to be relevant and will therefore be returned as a search result, the search system may look for images not necessarily already associated with the first search record. For example, when searching for Pad Thai, a search result for a particular restaurant may be determined relevant. However, no pictures related to Pad Thai may be available for that restaurant. When an image is not available, or in some implementations even when images are available, the search system may attempt to identify a most relevant image corresponding to the search query. In other words, the search system in this example may attempt to find an exemplary picture of Pad Thai to include with the search result.

In any of the implementations described in more detail below, the search system may be constrained to select display component data already associated with a search result, without searching for display component data from other sources.

In some implementations, the search system selects display component data based on matches between the search query and metadata associated with the display component data. For example, the search system can select an image for a search result based on matches between the search query and metadata associated with the image. The search system then transmits search result data, including the selected display component data, to a user device along with other search result data (e.g., URLs) for rendering on the user device. The user device renders display components (e.g., images and/or user reviews) based on the received display component data (e.g., image data and/or review data). An example SERP may include a plurality of user-selectable search results, each of which can open web/native application states on the user device in response to a user selection. Each of the user-selectable search results may include one or more display components selected by the search system based on the metadata associated with the display components.

When searching for hotels, a user may have a particular preference other than a basic bed or length of stay requirement for a hotel. For instance, the user may prefer a room with a beach view, or a hot tub, etc. In these cases, instead of showing a general picture of the hotel, the search system may identify and provide an image corresponding to the particular preference in a modified search result for the hotel. For example, when the user has a preference for a beach view, the search result for the hotel may include an image of a room having a beach view, rather than a default image of the hotel or an image of some other type of room. The modified search result offers the user a more personalized experience and can enhance click-through rates versus non-modified search results having default (non-relevant) images.

In another example, the search system can provide modified search results to a user searching for a car to purchase. Besides basic information, such as make, model, price, etc., the search system can offer users with more search options, such as specifications (like interior color, exterior color, etc.) and features (such as 3rd-row seats, tinted windows, etc.). However, even though these options are offered, the images of non-modified search results may be generic images and the user may not be able to visually access feature-specific images without navigating further into the non-modified search results.

The search system described herein can provide modified search results having images relevant to a search query or preferences of the user. In this example, when the user queries for a car having specific interior features, the search system returns modified search results having images relevant to the specific interior features. As a result, the user can see the specific interior features in the search results of the query without further action. Other examples are possible as well, where the search system provides the user with display components (e.g., images, review data, etc.) relevant to a search query, user intent, and/or user preference.

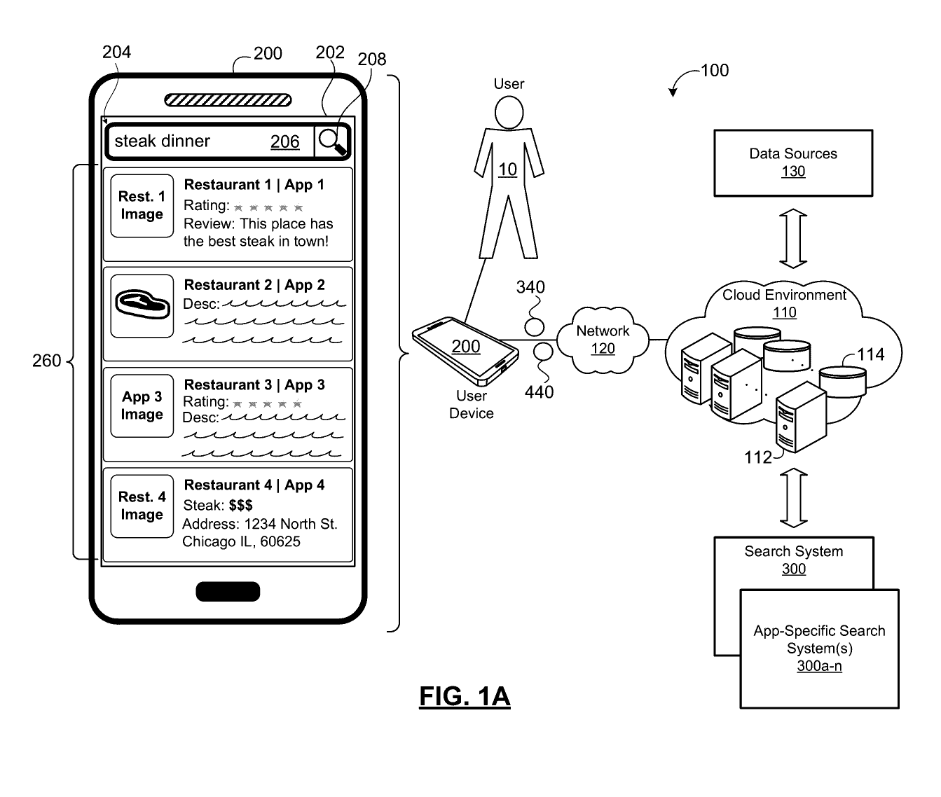

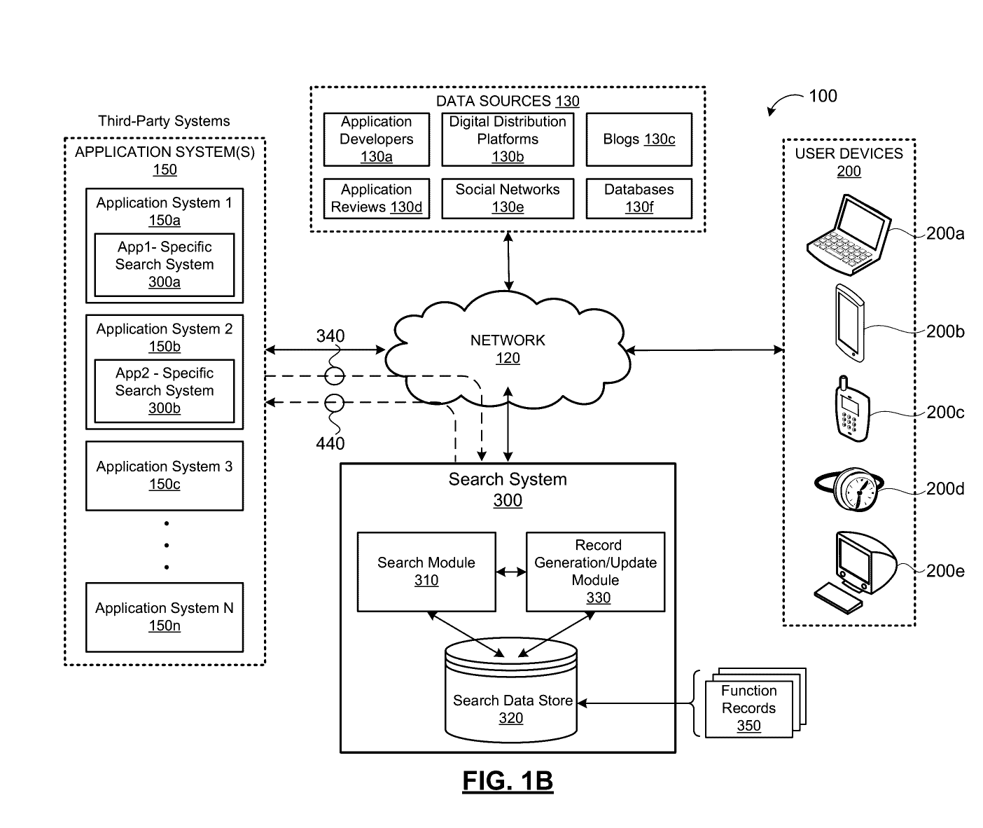

FIG. 1A illustrates an example system 100 that includes a user device 200 associated with a user 10 in communication with a remote system 110 via a network 120. FIG. 1B provides a functional block diagram of the system 100. The remote system 110 may be a distributed system (e.g., cloud environment) having scalable/elastic computing resources 112 and/or storage resources 114. The user device 200 and/or the remote system 110 may execute a search system 300 and optionally receive data from one or more data sources 130. In some implementations, the search system(s) 300, 300a-n communicates with one or more user devices 200 and the data source(s) 130 via the network 120. The network 120 may include various types of networks, such as a local area network (LAN), wide area network (WAN), and/or the Internet.

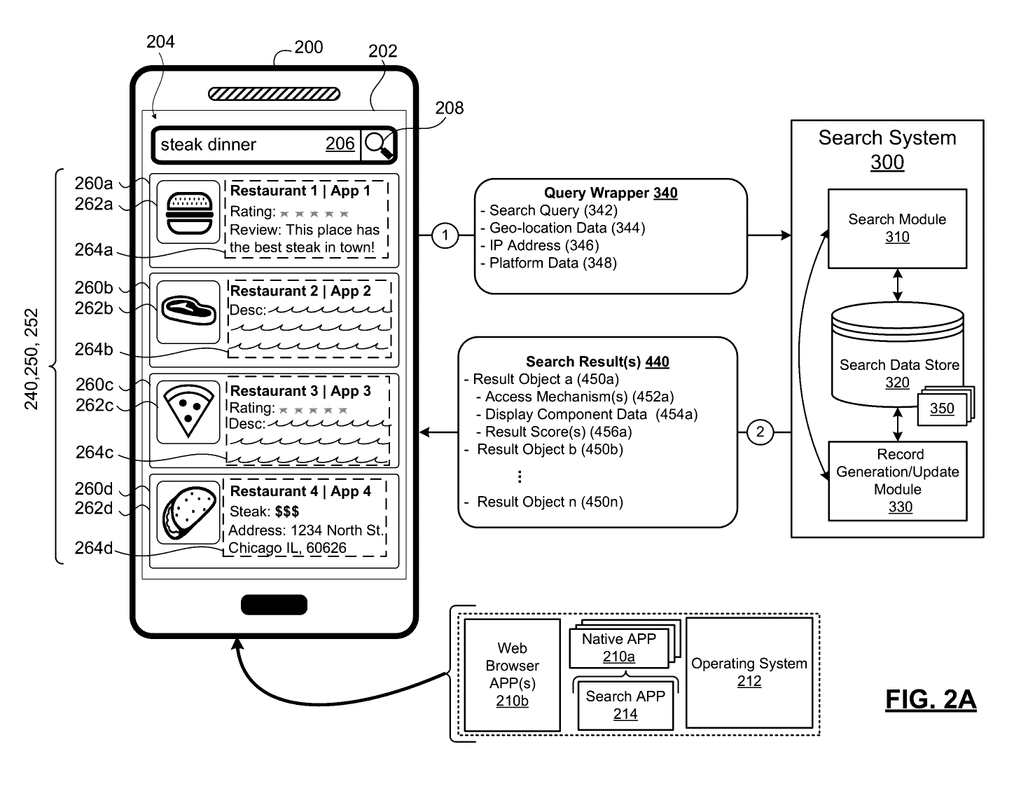

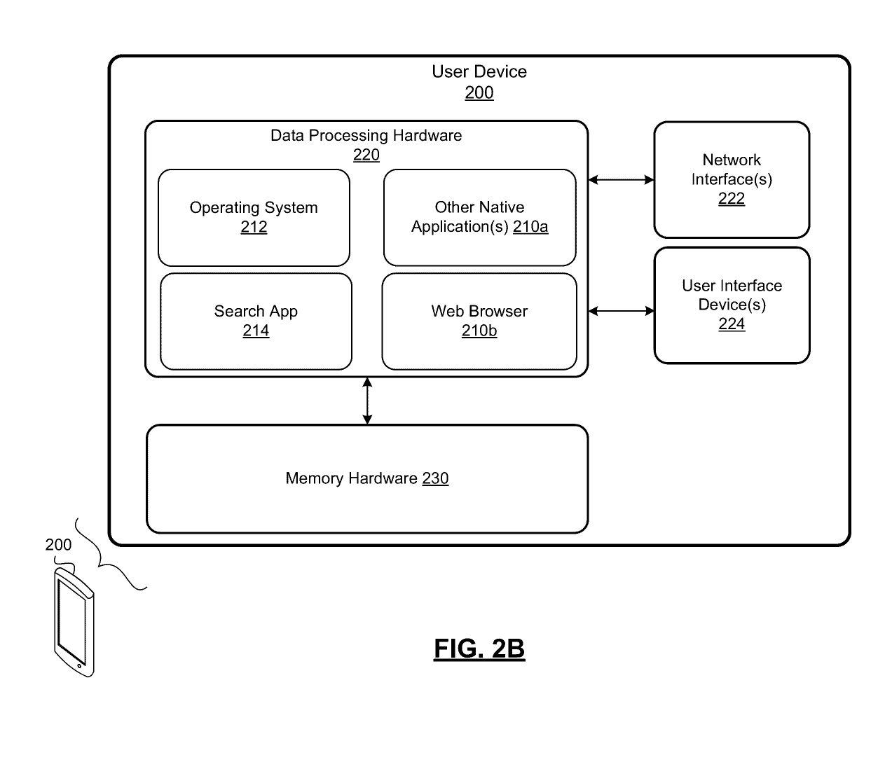

FIG. 2A shows an example user device 200 in communication with the search system 300. FIG. 2B shows an example user device. User devices 200 can be any computing devices that are capable of providing queries 342 (e.g., in query wrappers 340) to the search system 300. User devices 200 include, but are not limited to, mobile computing devices, such as laptops 200a, tablets 200b, smartphones 200c, and wearable computing devices 200d (e.g., headsets and/or watches). User devices 200 may also include other computing devices having other form factors, such as computing devices included in desktop computers 200e, vehicles, gaming devices, televisions, or other appliances (e.g., networked home automation devices and home appliances).

The user device 200 may execute one or more software applications 210. A software application 210 may refer to computer software that, when executed by a computing device, causes the computing device to perform a task. In some examples, a software application 210 may be referred to as an “application,” an “app,” or a “program.” Example software applications 210 include, but are not limited to, word processing applications, spreadsheet applications, messaging applications, media streaming applications, social networking applications, and games. In some examples, applications 210 may be installed on the user device 200 prior to a user 10 purchasing the user device 200. In other examples, the user 10 may download and install applications 210 on the user device 200.

The user device 200 may use a variety of different operating systems 212. In examples where the user device 200 is a mobile device, the user device 200 may run an operating system including, but not limited to, ANDROID® developed by Google Inc., IOS® developed by Apple Inc., or WINDOWS PHONE® developed by Microsoft Corporation. Accordingly, the operating system 212 running on the user device 200 may include, but is not limited to, one of ANDROID®, IOS®, or WINDOWS PHONE®. In an example where a user device is a laptop or desktop computing device, the user device may run an operating system including, but not limited to, MICROSOFT WINDOWS® by Microsoft Corporation, MAC OS® by Apple, Inc., or Linux. The user device 200 may also access the search system 300 while running an operating system 212 other than those operating systems 212 described above, whether presently available or developed in the future.

FIG. 2B illustrates an example user device 200 that includes data processing hardware 220 in communication with memory hardware 230, a network interface device 222, and a user interface device 224, such as a screen 202. The user device 200 may include other components not explicitly depicted. In implementations where the data processing hardware 220 includes two or more processors, the processors can execute in a distributed or individual manner. The memory hardware 230 stores instructions that when executed by the data processing hardware 220 cause the data processing hardware 220 to perform one or more operations. The memory hardware 230 may store computer readable instructions that make up a native application 210a, a web browser 210b, and/or the operating system 212. The operating system 212 acts as an interface between the data processing hardware 220 and the applications 210.

The network interface 222 includes one or more devices configured to communicate with the network 120. The network interface 222 can include one or more transceivers for performing wired or wireless communication. Examples of the network interface 222 may include, but are not limited to, a transceiver configured to perform communications using the IEEE 802.11 wireless standard, an Ethernet port, a wireless transmitter, and a universal serial bus (USB) port. The user interface 224 includes one or more devices configured to receive input from and/or provide output to the user 10. The user interface 224 can include, but is not limited to, a touchscreen 202, a display, a QWERTY keyboard, a numeric keypad, a touchpad, a microphone, and/or speakers.

In general, the user device 200 may communicate with the search system 300 using any software application 210 that can transmit search queries 342 to the search system 300 or an app-specific search system 300a-n. In some examples, the user device 200 runs a native application 210a that is dedicated to interfacing with the search system 300, such as a native application 210a dedicated to searches (e.g., a search application 214). In some examples, the user device 200 communicates with the search system 300 using a more general application 210, such as a web-browser application 210b accessed using a web browser. Although the user device 200 may communicate with the search system 300 using a native application 210a and/or a web-browser application 210b, the user device 200 may be described hereinafter as using the native search application 214 to communicate with the search system 300.

The search system 300 can be implemented in a variety of different ways. In the example shown, the search system 300 is a general search system that searches across a variety of different applications 210 and verticals (e.g., web, images, video, etc.). The search system 300 is in communication with one or more application systems 150, 150a-n having corresponding app-specific search systems 300a-n via the network 120. Alternatively, the search system 300 can be a general search system and/or an app-specific search system operated by an owner for a specific application 210. For example, a restaurant discovery application can provide an in-app search experience that searches content for the restaurant discovery application. In the example shown in FIG. 1B, the application systems 150, 150a-n represent different servers operated by specific application owners and the app-specific search systems 300a-n represent search system components for the applications 210 of the corresponding application systems 150, 150a-n.

Referring to FIGS. 1A-2B, in some implementations, the search system 300 includes a search module 310 in communication with a search data store 320 and a record generation/update module 330. The search data store 320 may include one or more databases, indices (e.g., inverted indices), tables, files, or other data structures which may be used to implement the techniques of the present disclosure. The search module 310 receives a query wrapper 340 and performs a search for function records 350 (also referred to as application state records) included in the search data store 320 based on data included in the query wrapper 340, such as a search query 342. The function records 350 include one or more access mechanisms 452 that the user device 200 can use to access different functions for a variety of different applications 210, such as native applications 210a installed on the user device 200.

The search module 310 generates search results 440 based on the data included in the data store 320 and transmits the search results 440 to the user device 200. In some implementations, the search module 310 generates result scores 456 for the search results 440 identified during the search. The result score 456 associated with each search result 440 may indicate the relevance of the search result 440 to the search query 342 (e.g., in order to rank each search result 440). A higher result score 456 may indicate that the search result 440 is more relevant to the search query 342. The search module 310 may also retrieve access mechanisms 452 for the scored search result 440. The search results 440 include result objects 450, each including one or more access mechanisms 452, display component data, 454, and/or a result score 456. The app-specific search systems 410, 410a-n may include the same, similar, or different components.

As shown and as will be discussed, the user device 200, the search system 300, and the application system(s) 150 are separate modules. However, in other implementations, the application system(s) 150 executes on the user device 200 and the search system 300 executes remotely. In this case, the application system(s) 150 executes on the user device 200 so that the communication time between the two is kept to a minimum. In additional implementations, the application system(s) 150 is/are part of the search system 300 or in communication with the search system 300 and executed remotely from the user device 200. In some examples, the application system(s) 150 is physically located about or near the search system 300, so that a communication time between the two is kept to a minimum. The application system(s) 150 may be part of the search system 300, and in other examples, the search system 300 is part of the application system(s) 150.

FIG. 2A illustrates interaction between the user device 200 and the search system 300. In the example shown, the search application 214 displays, on a screen 202 of the user device 200, a graphical user interface (GUI 204) having a search field 206 and a search button 208. The user device 200 receives a search query 342 from the user 10 via the GUI 204. In general, the search query 342 may be a request for information retrieval (e.g., search results 440) from the search system 300, and may include text, numbers, and/or symbols (e.g., punctuation). The user 10 may enter the search query 342 into the search field 206 and select the search button 208 to initiate execution of a search of the search system 300. The user 10 may enter a search query 342 using a touchscreen keypad, a mechanical keypad, a speech-to-text program, or another form of user input. Other methods of inputting the search query 342 are possible as well.

In response to receiving the search query 342, the user device 200 (e.g., via the search app 214) transmits a query wrapper 340, which includes the search query 342, to the search system 300 (e.g., to the search module 310). The query wrapper 340 may include additional data along with the search query 342. For example, the query wrapper 340 may include: geolocation data 344 that indicates a location of the user device 200, such as latitude and longitude coordinates from a global positioning system (GPS) receiver of the user device 200; an IP address 346 that the search module 310 may use to determine the location of the user device 200; and/or platform data 348 (e.g., a version of the operating system 212, a device type, or a web-browser version). Additional information may include, but is not limited to, an identity of the user 10 of the user device 200 (e.g., a username), partner specific data, or other data.

In response to receiving the query wrapper 340, the search system 300 implements a search based on the search query 342 (included in the query wrapper 340) and generates search results 440. The search system 300 may retrieve data from one or more of the data sources 130, as shown in FIG. 1B, relevant to the search query 342. In some implementations, the search system 300 selects display component data 454 based on matches between the search query 342 and metadata associated with the display component data 454. For example, the search system 300 can select an image for a search result 440 based on matches between the search query 342 and metadata associated with the image.

The data sources 130 may be sources of data which the search system 300 (e.g., the search module 310) may use to generate and update the data store 320. The data retrieved from the data sources 130 can include any type of data related to application functionality and/or application states. Data retrieved from the data sources 130 may be used to create and/or update one or more databases, indices, tables (e.g., an access table), files, or other data structures included in the data store 320. For example, function records 350 may be created and updated based on data retrieved from the data sources 130. In some examples, some data included in a data source 130 may be manually generated by a human operator. Data included in the function records 350 may be updated over time so that the search system 300 provides up-to-date results.

The data sources 130 may include a variety of different data providers. The data sources 130 may include data from application developers 130a, such as application developers' websites and data feeds provided by developers. The data sources 130 may include operators of digital distribution platforms 130b configured to distribute native applications 210a to user devices 200. Example digital distribution platforms 130b include, but are not limited to, the GOOGLE PLAY® digital distribution platform by Google, Inc., the APP STORE® digital distribution platform by Apple, Inc., and WINDOWS PHONE® Store developed by Microsoft Corporation.

The data sources 130 may also include other websites, such as websites that include blogs 130c, application review websites 130d, or other websites including data related to applications. Additionally, the data sources 130 may include social networking sites 130e, such as FACEBOOK® by Facebook, Inc. (e.g., Facebook posts) and TWITTER® by Twitter Inc. (e.g., text from tweets). Data sources 130 may also include online databases 130f that include, but are not limited to, data related to movies, television programs, music, and restaurants. Data sources 130 may also include additional types of data sources in addition to the data sources described above. Different data sources 130 may have their own content and update rate.

After generating/obtaining the search results 440, the search module 310 transmits search results 440 back to the user device 200, which renders the search results 440 (e.g., in a SERP) on the screen 202 of the user device 200 as displayed search results 240. The search results 440 include a plurality of result objects 450, 450a-n. Each result object 450, 450a-n represents data for displaying a single search result 440. In some implementations, the result object 450, 450a-n includes one or more access mechanisms 452, 452a-n, display component data 454, 454a-n for one or more display components 250, and/or a result score 456, 456a-n. The result score 456 indicates the relative rank of the displayed search result 240.

The user device 200 receives the search results 440 from the search system 300 and displays the search results 440 to the user 10 as displayed search results 240 including one or more displayed objects 260, 260a-n, each corresponding to a result object 450 of the search results 440. Each displayed object 260 may include a user-selectable link 252 (also referred to as a “link”) associated with an access mechanism 452 of the corresponding result object 450. Moreover, the user device 200 may display each displayed object 260 using the display component data 454 of the corresponding result object 450 (e.g., included in the search results 440). The user device 200 uses the display component data 454 to render one or more display components 250 as the user-selectable link(s) 252 associated with each displayed result object 260. Furthermore, the search application 214 or web-browser search application 210b may arrange the displayed result object 260 in an order based on result scores 456 associated with the access mechanisms 452 included in the displayed result object 260.

Each result object 450 includes display component data 454. The display component data 454 may include an image 262, 362 (e.g., an icon), text 264 (e.g., an application or business name) that may describe an application 210 and a state of the application 210, or other data. Each result object 450 may include an access mechanism 452 so that when the user 10 selects the corresponding displayed result object 260 (via a corresponding user-selectable link 252), the user device 200 launches the associated application 210 and sets the application 210 into a state specified by the access mechanism 452. In some examples, the user 10 may select a user-selectable link 252 associated with a display component 250 by interacting with the link 252 (e.g., touching or clicking the link). In response to selection of the link 252, the user device 200 may launch a corresponding software application 210 (e.g., a native application 210a or a web-browser application 210b) referenced by the access mechanism 452 and perform one or more operations indicated in the access mechanism 452

Access mechanisms 452 may include at least one of a native application access mechanism 452a (hereinafter “application access mechanism”), a web access mechanism 452b, or an application download mechanism 452c. The user device 200 may use the access mechanisms 452 to access functionality of applications 210 via a uniform resource locator (URL). Therefore, the access mechanism 452 is also referred to a functional URL. For example, the user 10 may select a user-selectable link 252 including an application access mechanism 452a in order to access functionality of an application 210 indicated in the user-selectable link 252. The application access mechanism 452a may be a string that includes a reference to a native application 210a and indicates one or more operations for the user device 200 to perform.

The application access mechanism 452a includes data that the user device 200 can use to access functionality provided by a corresponding native application 210a. For example, an application access mechanism 452a may include data that causes the user device 200 to launch a corresponding native application 210a and perform a function associated with the native application 210a. Performance of the function may set the native application 210a into a specified state. Accordingly, the process of launching the native application 210a and performing the function according to the application access mechanism 452a may be referred to herein as launching the native application 210a and setting the native application 210a into a state that is specified by the application access mechanism 452a.

For example, an application access mechanism 452a for a restaurant reservation application can include data that causes the user device 200 to launch the restaurant reservation application and assist in making a reservation at a restaurant. In such examples, the restaurant reservation application may be set in a state that displays reservation information to the user 10, such as a reservation time, a description of the restaurant, and user reviews.

Application access mechanisms 452a may have various different formats and content. The format and content of an application access mechanism 452a may depend on the native application 210a with which the application access mechanism 452a is associated and the operations that are to be performed by the native application 210a in response to selection of the application access mechanism 452a. In general, a state of a native application 210a may refer to the operations and/or the resulting outcome of the native application 210a in response to selection of a link 252. A state of a native application 210a may also be referred to herein as an “application state.”

For example, an application access mechanism 452a for an internet music player application may differ from an application access mechanism 452a for a shopping application. The application access mechanism 452a for the internet music player application may include references to musical artists, songs, and albums, for example. The application access mechanism 452a for the internet music player application may also reference operations, such as randomizing a list of songs and playing a song or album. The application access mechanism 452a for the shopping application may include references to different products that are for sale, and may also include references to one or more operations, such as adding products to a shopping cart and proceeding to a checkout.

A web access mechanism 452b may include a resource identifier that includes a reference to a web resource (e.g., a page of a web application/website). For example, a web access mechanism 452b may include a uniform resource locator (URL) (i.e., a web address) used with hypertext transfer protocol (HTTP). If the user 10 selects a user-selectable link 252 including a web access mechanism 452b, the user device 200 may launch the web browser application 210b and retrieve the web resource indicated in the resource identifier. Put another way, if the user 10 selects a user-selectable link 252 including a web access mechanism 452b, the user device 200 may launch a corresponding web-browser application 210b and access a state (e.g., a page) of a web application/website. In some examples, web access mechanisms 452 include URLs for mobile-optimized sites and/or full sites.

The web access mechanism 452b included in an application state record 350 may be used by a web browser to access a web resource that includes similar information and/or performs similar functions as would be performed by a native application 210a that receives an application access mechanism 452a of the application state record 350. For example, the web access mechanism 452b of an application state record 350 may direct the web-browser application 210b of the user device 200 to a web version of the native application 210a referenced in the application access mechanisms 452a of the application state record 350. Moreover, if the application access mechanisms 452a included in an application state record 350 for a specific Mexican restaurant causes each application edition to retrieve information for the specific Mexican restaurant, the web access mechanism 452b may direct the web-browser application 210b of the user device 200 to a web page entry for the specific Mexican restaurant.

An application download mechanism 452c may indicate a location (e.g., a digital distribution platform 130b) where a native application 210a can be downloaded in the scenario where the native application 210a is not installed on the user device 200. If the user 10 selects a user-selectable link 252 including an application download mechanism 452c, the user device 200 may access a digital distribution platform from which the referenced native application 210a may be downloaded. The user device 200 may access a digital distribution platform 130b using at least one of the web-browser application 210b and one of the native applications 210a.

When the user 10 searches for a specific item (e.g., a dish/food), the user 10 generally wishes to view displayed search results 240 having images 262 of the specific item, rather than generic/preset images 262 not of the specific item searched. For example, for a search query 342 of “salad,” the user 10 may wish to view an image 262 of the actual salad provided by a corresponding restaurant listed in the displayed search results 240, rather than an image 262 of the restaurant of some other food item. In the example shown in FIG. 2A, the user device 200 is executing a general search for a “steak dinner.” The displayed search results 240 are for various apps 210, and the display component data 454 for the search results 440 differ. A display component 250 in the form of an image 262b of a steak appears instead of an image 262 for the corresponding restaurant or some other food item. In this example, display components 250 include ratings, user reviews, descriptions, price indicators, and addresses. Other display components 250 are possible as well. Moreover, these display components 250 may vary among the different displayed search results 240.

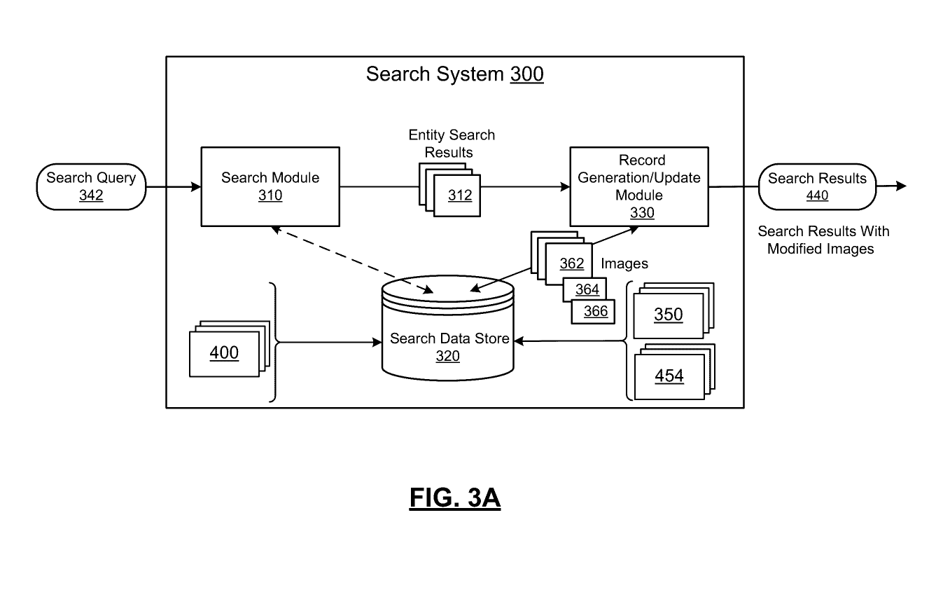

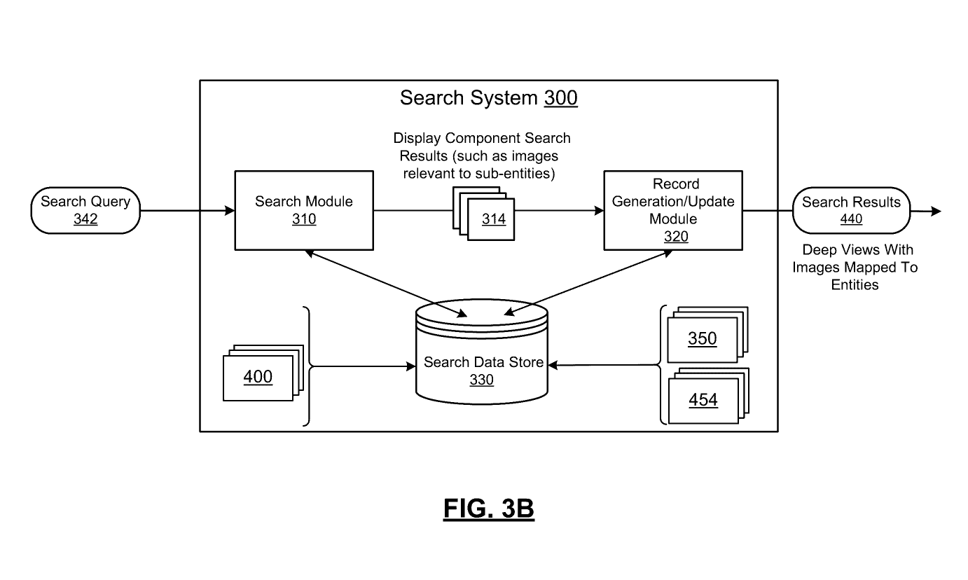

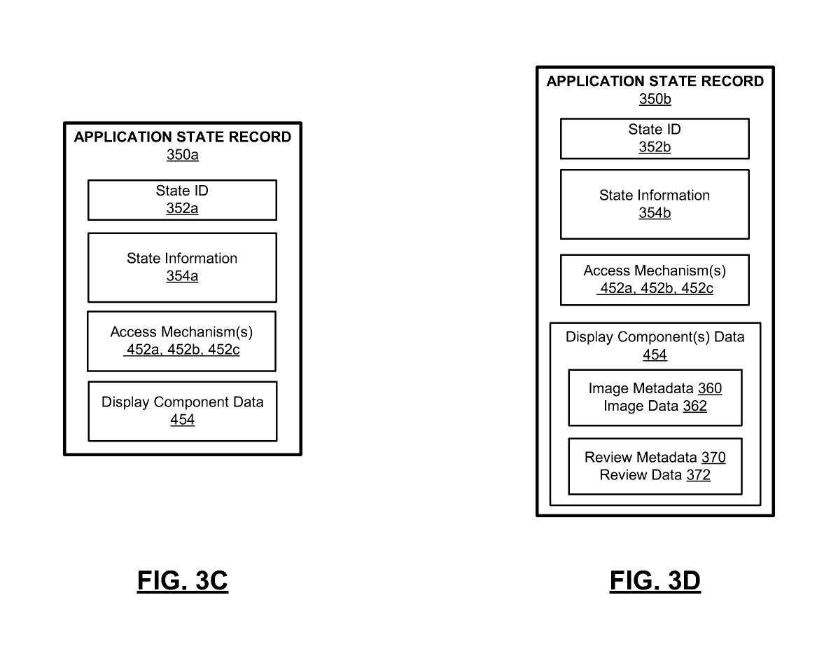

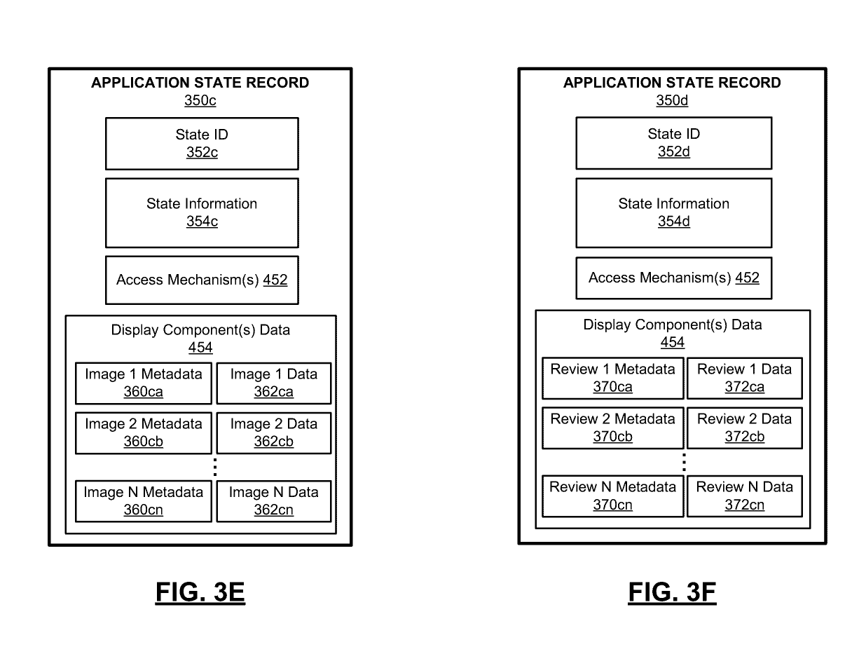

Referring to FIG. 3A, in some implementations, after receiving the query wrapper 340 at the search system 300, 300a-n (general or app-specific), the search module 310 performs a first search of the search data store 320 based on the search query 342 and generates entity search results 312 (e.g., a set of entity records 400).

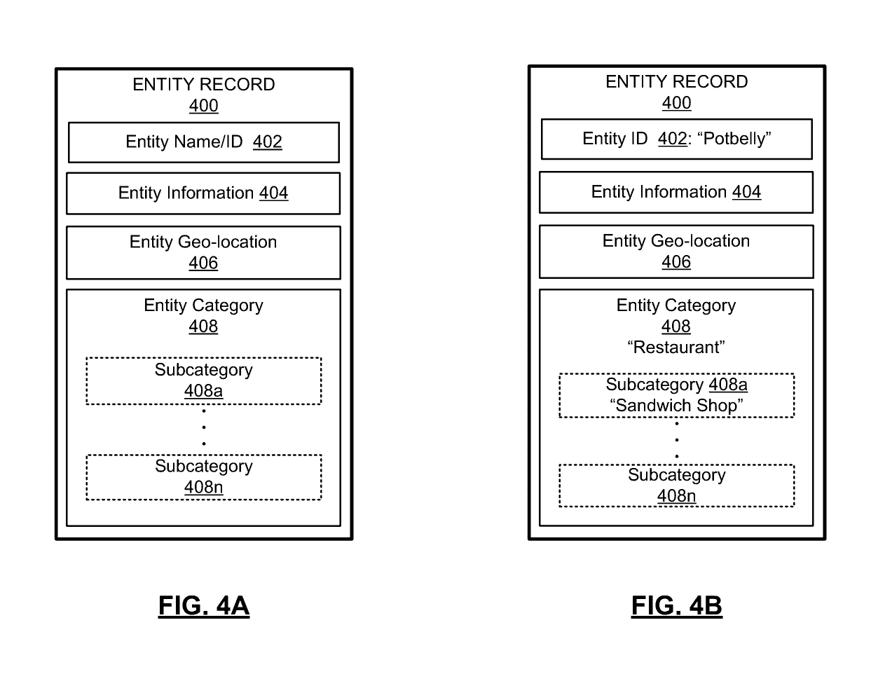

Each entity search result 312 is associated with an entity (e.g., an entity record 400) relevant to the search query 342 and optionally associated with display results (e.g., application state records 350) including modifiable parts, i.e., sub-entities, such as display component data 454 for display components 250 renderable by the user device 200. Application state records 350 are described further with reference to FIGS. 3C-3F; and entity records 400 are described further with reference to FIGS. 4A and 4B. The modifiable parts or display component data 454 can be for images, reviews, menu items, etc.

The record generation/update module 330 may execute a second search of the search data store 320 to identify display component data 454 (e.g., one or more images 362 or other corresponding modifiable part of the displayable search result) relevant to the search query 342 for each entity search result 312. The record generation/update module 330 may associate or modify the entity search result 312 to/with the identified display component data 454. For example, the record generation/update module 330 may associate or modify display component data 454 (e.g., image data 362 and/or review data 372) of the identified application state records 350 of the entity search result 312 to/with the identified display component data 454 to generate result objects 450 for the search results 440.

In one example, when the user 10 enters “salad” into the search field 206 and executes a search (by selecting the search button 208), the search module 310 of the search system 300 may search for entity records 400 corresponding to restaurants and associated with the word “salad.” For example, this natural language processing may use a so-called “bag-of-words” model, where the grammar of the query is ignored and occurrences of the words themselves.

The search system 300 may generate entity search results 312 including entity records 400 for each identified relevant entity, which in the case of this example would be restaurants offering salads. Next, the record generation/update module 330 executes a second search of the search data store 320 to identify display component data 454 (e.g., one or more images 362) corresponding to a salad for each entity record 400 (e.g., for each identified restaurant). In this example, one of the results objects 450 represents a restaurant named “Buffalo.” The record generation/update module 330 searches for and identifies one or more images 362 of a salad at the “Buffalo” restaurant. While generating the result objects 450, 450a-n of the search results 440, the record generation/update module 330 uses one of the identified images 262 in the display component data 454 for the results object 450 corresponding to the “Buffalo” restaurant. Moreover, the record generation/update module 330 uses other identified images 262 corresponding to salads for other restaurants in the result objects 450, 450a-n corresponding to those restaurants (entities) if any such images 362 were found. When more than one image 262 is identified, the record generation/update module 330 may select one image 262 for the corresponding result object 450 based one or more factors, such as a confidence score and a popularity score associated with each image 262, as described further herein.

Referring to FIG. 3B, in some implementations, after receiving the query wrapper 340 at the search system 300, 300a-n (general or app-specific), the search module 310 performs a first search of the search data store 320 based on the search query 342 and generates display component search results 314 including display component data 454, such as image data 362, review data 372, or other corresponding modifiable parts of a displayed results object 260, relevant to the search query 342. Next, the record generation/update module 330 may execute a second search of the search data store 320 to identify one or more entities (e.g., a set of entity records 400) relevant to the display component search results 314 and retrieves corresponding application state records 350. The record generation/update module 330 modifies or associates the display component data 454 (e.g., image data 362, review data 372, or another modifiable part of the corresponding displayed result object 260) with the application state records 350 to generate the search results 440 (e.g., to generate the result objects 450, 450a-n).

In one example, when the user 10 enters “salad” into the search field 206 and executes a search (by selecting the search button 208), the search module 310 of the search system 300 may search for images 362 associated with the word “salad” (e.g., using a bag-of-words approach). The search system 300 may generate entity search results 312 including images 362 representing a salad. Next, the record generation/update module 330 executes a second search of the search data store 320 to identify one or more entities (e.g., one or more entity records 400 and optionally associated application state records 350) corresponding to the images 362 of the entity search results 312. In this example, one of the images 362 is for a salad at the “Buffalo” restaurant, and the record generation/update module 330 identifies an application state record 350 and an associated entity record 400 for the “Buffalo” entity. The record generation/update module 330 modifies a result object 450 corresponding to the “Buffalo” entity to have the identified image 362 of the salad.

The search systems 300 described with reference to FIGS. 3A and 3B can be implemented in a general search system and/or an app-specific search system (e.g., in-app search engine). Referring again to FIGS. 1B and 3A, in some implementations an application system 150 sends a query wrapper 340 to the general search system 300 (e.g., via an app-specific search system 300a-n). The query wrapper 340 includes a search query 342 and entity search result 312. The search module 310 acknowledges the received entity search result 312 and skips the first search of the search data store 320, passing the received entity search result 312 to the record generation/update module 330, which executes the second search of the search data store 320 to identify one or more images 362 (or other corresponding modifiable part (display component data 454)) relevant to the search query 342 for each entity search result 312. After generating the search results 440 or merely an association of images 362 to the entity search results, the general search system 300 sends the search results 440 to the app-specific search system 300a-n.

The search system 300 may use one or more parameters to determine which display component data 454 (e.g., image data 262, 362) among other possible matching display component data 454 to include the search results 440. A confidence score 364 and a popularity score 366 are two parameters, among others, that the search system 300 may use for identifying/selecting display component data 454.

For images 262, 362, the popularity score 366 can be based on an image score and/or a rating distribution. For example, each image 262, 362 may have an associated score given by users 10 (e.g., reviewers) that indicates whether the image 262, 362 is helpful or not. A rating distribution may be a score indicating a reputation of the user 10, i.e., how many other users 10 find his/her reviews useful, etc. Each user 10 may have an associated profile indicating the reputation of the user 10. The search system 300 may use the reputation of the user 10 to determine overall popularity scores 366 for images 262 uploaded by the user 10. The confidence score 364 may indicate how close the search query 342 relates to or matches the metadata 360 associated with the image 262, 362. In some examples, the confidence score 364 is based on a level of matching by keywords, tags, text, etc., providing an indicator of the content of the image 262, 362. Images 262, 362 having a high confidence score 364 and a high popularity score 366 may be a good match for the search query 342. In some examples, the confidence score 364 outweighs the popularity score 366, because the confidence score 364 may need to be relatively more accurate than the popularity score 366. The search system 300 may generate the popularity score 366 for every image 262, 362 in the search data store 320. The search system 300 may also generate also the confidence score 364 can for each query/image match (e.g., at search time). When the confidence score 364 and the popularity score 366 are high, the search system 300 may return a search result 440 (e.g., a result object 450) having the corresponding image 262, 362 in the associated display component data 454. When the confidence score 364 and the popularity score values are low, the search system 300 may discard the image 262, 362 and/or the search result 440 (e.g., the result object 450) having the corresponding image 262, 362 in the associated display component data 454. When the confidence scores 364 and the popularity scores 366 are low across all images 262, 362, the search system 300 may return a search result 440 (e.g., a result object 450) having the image 262, 362 with the highest scores in the associated display component data 454. In some examples, when the confidence scores 364 and the popularity scores 366 for all images 262, 362 are below a threshold value, the search system 300 may return a search result 440 (e.g., a result object 450) with a default image 262, 362 in the associated display component data 454.

In these implementations, the search system 300 may utilize a set of rules that determine the confidence scores 364 of recognized entities. Examples of such rules may be found, for example, in U.S. patent application Ser. No. 14/339,588, filed on Jul. 24, 2014, the relevant contents of which are herein incorporated by reference.

Referring to FIGS. 3C-3F illustrate example application state records 350. Each application state record 350 may include data related to a function of an application 210 and/or the state of the application 210 resulting from performance of the function. An application state record 350 may include an application state identifier (ID) 352, application state information 354, one or more access mechanisms 452, 452a, 452b, 452c used to access functionality provided by an application 210, and display component data 454.

The application state ID 352 may be used to identify the application state record 350 among the other application state records 350 included in the search data store 320. The application state ID 352 may be a string of alphabetic, numeric, and/or symbolic characters (e.g., punctuation marks) that uniquely identifies the associated application state record 350. In some examples, the application state ID 352 describes a function and/or an application state in human-readable form. For example, the application state ID 352 may include the name of the application 210 referenced in the access mechanism(s) 452. In a specific example, an application state ID 352 for an internet music player application may include the name of the internet music player application along with the song name that will be played when the internet music player application is set into the state defined by the application access mechanism included in the application state. Additionally or alternatively, the application state ID 352 may be a human readable string that describes a function performed according to the access mechanism(s) 452 and/or an application state resulting from performance of the function according to the access mechanism(s) 452. In some examples, the application state ID 352 includes a string in the format of a uniform resource locator (URL) of a web access mechanism 452b for the application state record 350, which may uniquely identify the application state record 350. In some examples, the string may include multiple parameters used to retrieve the corresponding application state record 350. In addition, some parameters may be user-generated, which means that the parameters put the application in a new application state record 350 that has not been previously executed. Thus, the user-selectable link 252 may not explicitly correspond to a known end result inside the application, but simply fits a known link expression that the application accepts. For example, the UBER application may display a user-selectable link 252 that uses a latitude and longitude as a parameter to determine location.

In a more specific example, if the application state record 350 describes a function of the YELP® native application, the application state ID 352 may include the name “Yelp” along with a description of the application state described in the application state information 354. For example, the application state ID 352 for an application state record 350 that describes the restaurant named “The French Laundry” may be “Yelp—The French Laundry.” In an example where the application state ID 352 includes a string in the format of a URL, the application state ID 352 may include the following string “http://www.yelp.com/biz/the-french-laundry-yountville-2?ob=1” to uniquely identify the application state record 350. In additional examples, the application state ID 352 may include a URL using a namespace other than “http://,” such as “func://,” which may indicate that the URL is being used as an application state ID in an application state. For example, the application state ID 352 may include the following string “func://www.yelp.com/biz/the-french-laundry-yountville-2?ob=1.”

The application state information 354 may include data that describes an application state into which an application 210 is set according to the access mechanism(s) 452 in the application state record 350. Additionally or alternatively, the application state information 354 may include data that describes the function performed according to the access mechanism(s) 452 included in the application state record 350. The application state information 354 may include text, numbers, and symbols that describe the application state. The types of data included in the application state information 354 may depend on the type of information associated with the application state and the functionality specified by the application access mechanism 452a. The application state information 354 may include a variety of different types of data, such as structured, semi-structured, and/or unstructured data. The application state information 354 may be automatically and/or manually generated based on documents retrieved from the data sources 130. Moreover, the application state information 354 may be updated so that up-to-date search results 440 are provided in response to a search query 342.

In some examples, the application state information 354 includes data that may be presented to the user 10 by an application 210 when the application 210 is set in the application state defined by the access mechanism(s) 452. For example, if one of the access mechanism(s) 452 is an application access mechanism 452a, the application state information 354 may include data that describes a state of the native application 210a after the user device 200 has performed the one or more operations indicated in the application access mechanism 452a. For example, if the application state record 350 is associated with a shopping application, the application state information 354 may include data that describes products (e.g., names and prices) that are shown when the shopping application is set to the application state defined by the access mechanism(s) 452. As another example, if the application state record 350 is associated with a music player application, the application state information 354 may include data that describes a song (e.g., name and artist) that is played when the music player application is set to the application state defined by the access mechanism(s) 452.

The types of data included in the application state information 354 may depend on the type of information associated with the application state and the functionality defined by the access mechanism(s) 452. For example, if the application state record 350 is for an application 210 that provides reviews of restaurants, the application state information 354 may include information (e.g., text and numbers) related to a restaurant, such as a category of the restaurant, reviews of the restaurant, and a menu for the restaurant. In this example, the access mechanism(s) 452 may cause the application 210 (e.g., a native application 210a or a web-browser application 210b) to launch and retrieve information relating to the restaurant. As another example, if the application state record 350 is for an application 210 that plays music, the application state information 354 may include information relating to a song, such as the name of the song, the artist, lyrics, and listener reviews. In this example, the access mechanism(s) 452 may cause the application 210 to launch and play the song described in the application state information 354.

The search system 300 may generate application state information 354 included in an application state record 350 in a variety of different ways. In some examples, the search system 300 retrieves data to be included in the application state information 354 via partnerships with database owners and developers of native applications 210a. For example, the search system 300 may automatically retrieve the data from online databases 130f that include, but are not limited to, data related to movies, television programs, music, and restaurants. In some examples, a human operator manually generates some data included in the application state information 354. The search system 300 may update data included in the application state information 354 over time so that the search system 300 provides up-to-date results 440 to the user 10.

An application state record 350 includes an application access mechanism 452 that causes an application 210 to launch into a default state may include application state information 354 describing the native application 210a, instead of any particular application state. For example, the application state information 354 may include the name of the developer of the application 210, the publisher of the application 210, a category (e.g., genre) of the application 210, a description of the application 210 (e.g., a developer's description), and a price of the application 210. The application state information 354 may also include security or privacy data about the application 210, battery usage of the application 210, and bandwidth usage of the application 210. The application state information 354 may also include application statistics. Application statistics may refer to numerical data related to a native application 210a. For example, application statistics may include, but are not limited to, a number of downloads, a download rate (e.g., downloads per month), a number of ratings, and a number of reviews.

In some examples, the application state record 350 includes display component data 454, which the user device 200 can use to render the displayed result object(s) 260 of the displayed search results 240. The display component data 454 may include information for images 262, text 264, and/or other displayable items. FIG. 3C illustrates an example application state record 350, 350a at a high level. FIG. 3D illustrates an example application state record 350, 350b that includes image metadata 360, image data 362, review metadata 370, and review data 372. FIG. 3E illustrates an example application state record 350, 350c that includes image metadata 360 and image data 362 for a plurality of images 362. FIG. 3F illustrates an example application state record 350, 350d that includes review metadata 370 and review data 372 (e.g., user review text) for a plurality of reviews 372. The search application 214 of the user device 200 may use the display component data 454 to structure and render the displayed search results 240 in the GUI 204.

Referring to FIGS. 3G and 3H, the search data store 320 includes a plurality of entity records 400. Each entity record 400 may include data related to an entity. The entity can be a business or place with a geolocation or person or event (e.g., restaurants, bars, gas stations, supermarkets, movie theaters, doctor offices, sports team, movie star, celebrity, politician, parks, and libraries, etc.). An entity record 400 may include an entity identifier or name (ID) 402, entity location data 406 (e.g., geolocation data), an entity category 408 (and optionally one or more sub-categories 408a-408n), and/or entity information 404.

The entity ID 402 may be used to identify the entity record 400 among the other entity records 400 included in the data store 320. The entity ID 402 may be a string of alphabetic, numeric, and/or symbolic characters (e.g., punctuation marks) that uniquely identifies the associated entity record 400. In some examples, the entity ID 402 describes the entity in human-readable form. For example, the entity ID 402 may include the name string of the entity or a human readable form identifying the entity. In some examples, the entity ID 402 includes a unique number that identifies the entity.

In a more specific example, if the entity record 400 describes a restaurant named POTBELLY®, the entity ID 402 for the entity record 400 can be “Potbelly.” In an example where the entity ID 402 includes a string in human readable form and/or a URL, the entity ID 402 may include the following string “Potbelly” to uniquely identify the entity record 400. Other unique identifiers are possible as well, such as a store number.

The entity information 404 may include any information about the entity, such as text (e.g., description, reviews) and numbers (e.g., the number of reviews). This information may even be redundant to other information contained in the entity record 400 but optionally structured for display, for example. The entity information 404 may include a variety of different types of data, such as structured, semi-structured, and/or unstructured data. Moreover, the entity information 404 may be automatically and/or manually generated based on documents retrieved from the data sources 130.

The entity location data 406 may include data that describes a location of the entity. This data may include a geolocation (e.g., latitude and longitude coordinates), a street address, or any information that can be used to identify the location of the entity. In some implementations, the entity location data 406 defines a geo-location associated with the application state record 350.

The entity category 408 provides a classification or grouping of the entity. Moreover, the entity category 408 can have one or more sub-categories 408a to further classify the entity. For example, the entity record 400 could have an entity category 408 of “restaurant” and a sub-category 408a of a type of cuisine, such as “Sandwich Shop,” “French cuisine,” or “contemporary.” Any number of sub-categories 408a-408n may be assigned to classify the entity for use during a search.

Referring again to FIGS. 3A and 3B, when the search module 310 performs the first search of the search data store 320 based on the search query 342, the search module 310 may search the entity records 400 to identify relevant entities (e.g., entity records 400) for generation of the entity search results 312, which can be a record set of entity records 400.

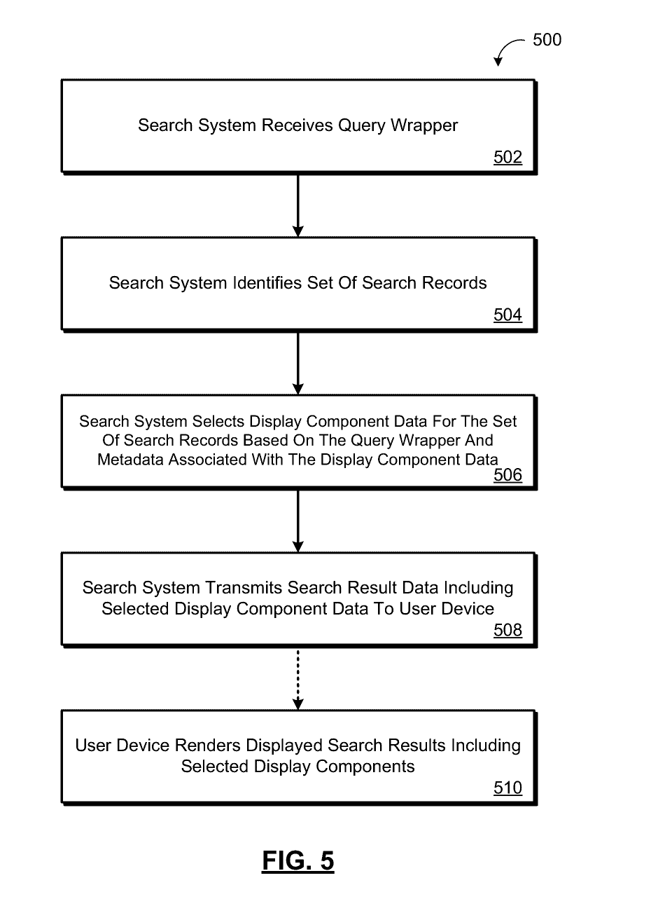

FIG. 5 illustrates an example method 500 for selecting display component data 454 and generating search results 440 based a received search query 342. The method 500 includes, at block 502, receiving, at the search system 300, a query wrapper 340 from the user device 200. The query wrapper 340 may include the user-entered search query 342 and additional data, such as geolocation data 344, an IP address 346, and platform data 348 (e.g., OS, device type). At block 504, the method 500 further includes identifying, at the search system 300, search results (e.g., a set of application state records 350) based on the received query wrapper 340. The search system 300 may identify the application state records 350 based on matches between the search query 342 and the application state information 354. The search system 300 may also filter/select the application state records 350 based on the geolocation data 344, the IP address 346, the platform data 348, and/or other data included in the query wrapper 340. At block 506, the method includes selecting, at the search system 300, display component data 454 for one or more display components 250 based on the query wrapper 340 and optionally the component metadata 360, 370. For example, the search system 300 may select image data 362 based on text matches between the search query 342 and image metadata 360 associated with the image data 362. Image metadata 360 may include comments (e.g., user comments) describing the image and user sentiments (e.g., ratings, thumbs up) indicating what users think of the corresponding image 362. The metadata 360, 370 may include descriptions or comments by a user 10 that uploaded the corresponding image data 362 or review data 372.

The display component data 454 for a single search result 440 can be ranked based on a variety of factors, such as the number of likes, comments, etc. A confidence score 364 may also be associated with the selected display component data 454. In this manner, one (or more) display components 250 for a single displayed result object 260 can be selected from a group of possible display components 250. In some cases, the search system 300 may not select display component data 454 for a custom display component 250 (e.g., an image), because of a low confidence score 364, for example. Instead, the search system 300 may select display component data 454 for a default display component 250 (e.g., a default image 262) for the displayed result object 260.

At block 508, the method 500 includes transmitting the search results 440 from the search system 300 to the user device 200, where the search results 440 include the selected display component data 454. At optional block 510, for explanatory purposes, the user device 200 renders displayed search results 240 including display components 250 corresponding to the selected display component data 454. For example, each displayed result object 260 includes one or more display components 250, such as an image 262 and/or text 264 corresponding to the selected display component data 454.

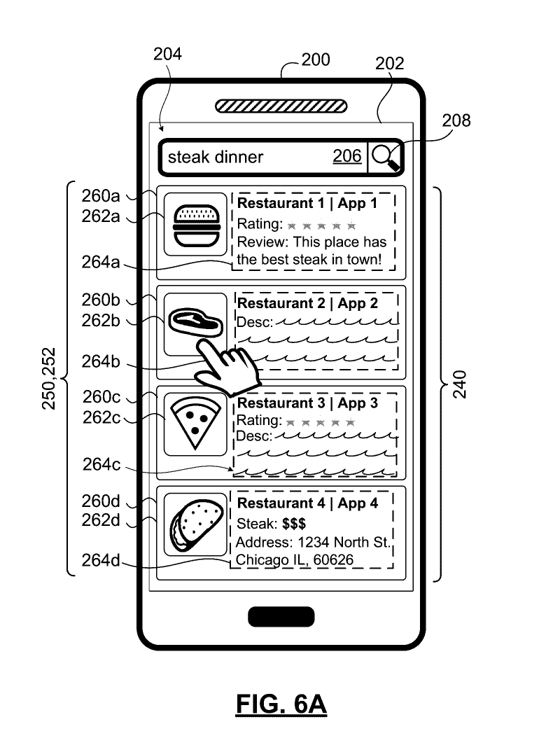

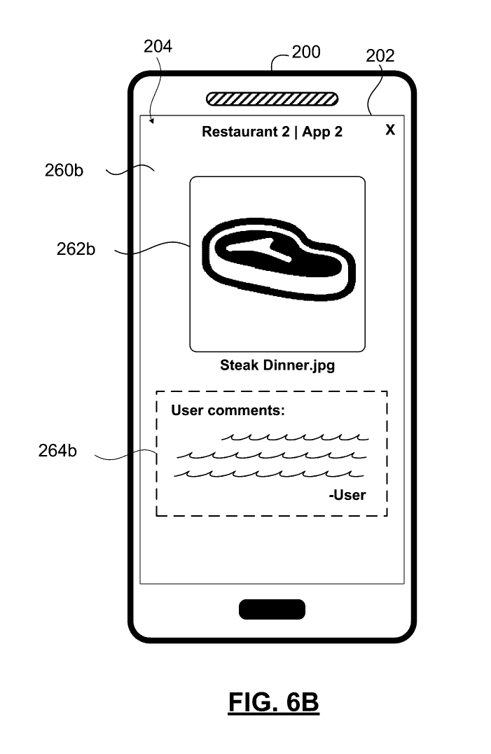

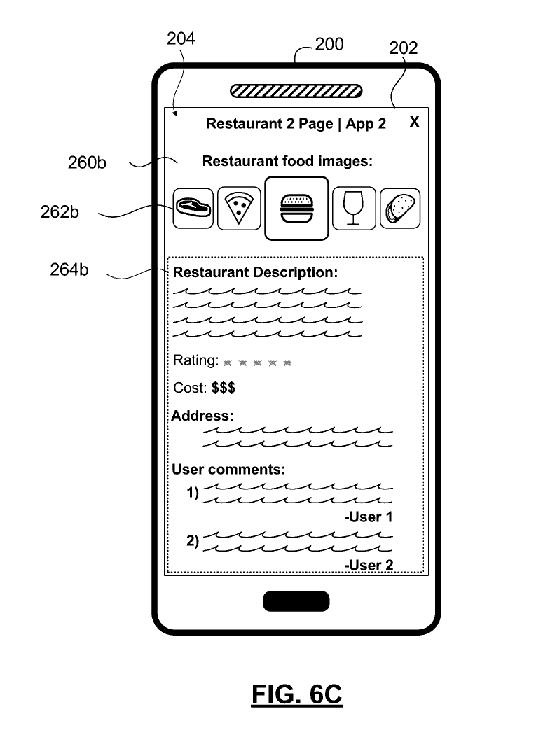

Referring to FIGS. 6A-6C, in some implementations, the user 10 can individually select display components 250 in the GUI 204 as user-selectable links 252. In these implementations, the displayed result object 450 provides the user 10 the option to look at specific portions (e.g., images 262, 362/reviews 264, 372) of an application 210 that the user 10 finds interesting in the displayed result object 450. In the example of FIG. 6A, touching the steak image 262b can launch an associated application 210 and set the application 210 to a state indicated by an application access mechanism 452 associated with the with the steak image 262b, which is functioning as a user-selectable link 252 in this example. FIG. 6B illustrates the launched application 210 set to the state indicated in the corresponding application access mechanism 452. FIG. 6C shows an alternate state of the application 210 represented by the corresponding displayed result object 450b. The alternate state includes the steak image 262b, which can also be a link 252 to more information about the steak image 262, as illustrated in FIG. 6B.

In some implementations, the displayed result object 450 includes a graphical indication that a display component 250 (e.g., an image 262) was selected based on the search query 342. For example, an image 262 may have a colored/highlighted border when the search system 300 selects the image 262, 362 based on associated image metadata 360 and/or the search query 342. In some implementations, a business (or other entity 400 associated with a search result 440) may upload display component data 454 362, 372 and metadata 360, 370 (e.g., image data 362 and image metadata 360) to the search data store 320 for inclusion in search results 440. For example, a restaurant business may upload images 362 with corresponding metadata 360 descriptions for selection by the search system 300 at search time. Accordingly, the pool of images 362 to choose from could come from a variety of different sources, such as the business owner and/or customers of the business.

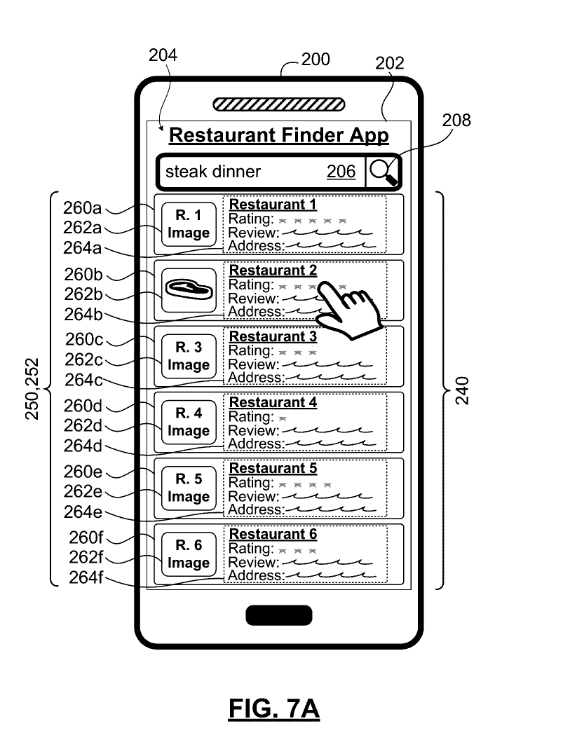

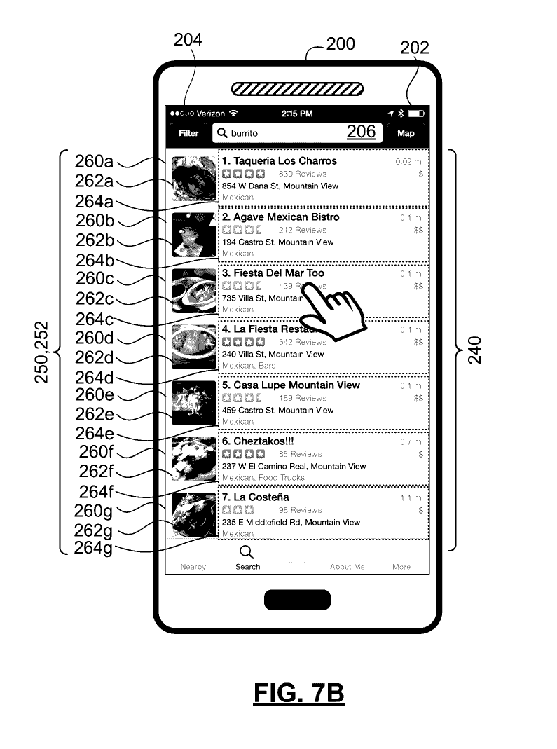

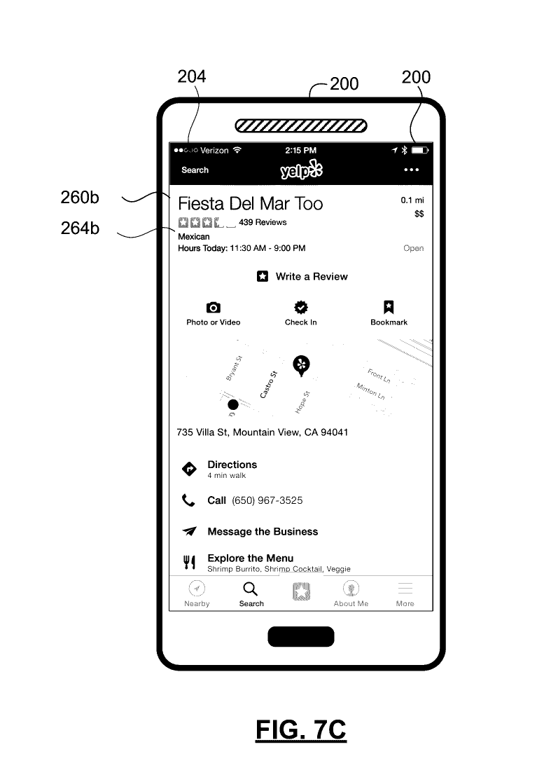

Referring to FIGS. 7A-7C, in some implementations, the displayed result object 450 is a single selectable area (e.g., a user-selectable link 252) including one or more display components 250, 262, 262a-f, 264, 264a-f. In these implementations, the displayed result object 450 can be associated with a single application access mechanism 452 that launches the corresponding application 210 and sets the application 210 to an indicated state. From a user standpoint, user interaction with the displayed search result 440, such as touching the displayed result object 450, launches the application state represented by the displayed result object 450. This may be beneficial to the user 10 in a case where the user device 200 has a small screen size (e.g., a smartphone), because the user 10 can more confidently select any portion of the displayed result object 450 to launch the same state, without concern of launching a certain state associated with a specific portion (e.g., image 262) of the displayed result object 450.

In the example shown in FIG. 7A, the “Restaurant Finder App” may be the same application 210 described with reference to FIGS. 6A and 6C, where selecting the displayed result object 260b for Restaurant 2 in FIG. 7A launches the associated application 210 and sets the application 210 to a state indicated by an application access mechanism 452 associated with the with the steak image 262b, which is functioning as a user-selectable link 252. FIG. 6C illustrates the launched application 210 set to the state indicated in the corresponding application access mechanism 452.

In the example shown in FIGS. 7B and 7C, when the user 10 selects a displayed result object 450, such as the displayed result object 260c for “Fiesta Del Mar Too” or some display component 250, which is functioning as a user-selectable link 252, the search application 210 launches the associated application 210 and sets the application 210 to a state indicated by an application access mechanism 452 associated with the with the user-selectable link 252. FIG. 7C illustrates the launched application 210 set to the state indicated in the corresponding application access mechanism 452.

In some examples, the displayed result objects 260 of the displayed search results 240 have the same format (e.g., locations of image data 362 and review data 372, etc. rendered in the displayed search results 240, but may differ in content (e.g., display components 250). In other examples, the displayed result objects 260 of the displayed search results 240 have different formats and content (e.g., display components 250). Moreover, although a specific item search and matching result image 262 is illustrated in FIGS. 6A, 6B, and 7A (e.g., the steak image 262b for a steak search query), in other examples text matches may not be related to specific item names. Instead, they may be related to other concepts or other display components 250 and display component data 454.

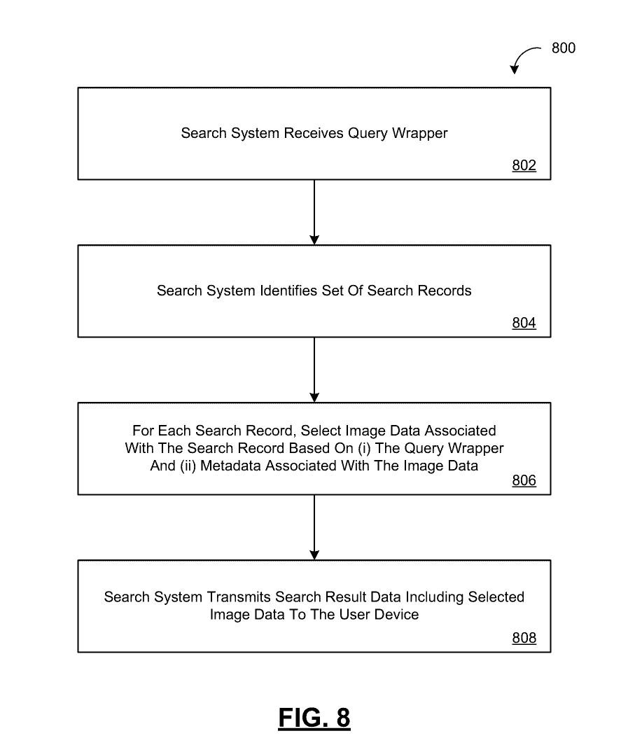

FIG. 8 provides an example arrangement of operations for a method 800 of selecting display component data 454 (e.g., image data 362, review data 372, or another modifiable part of a corresponding displayed result object 260). The method 800 includes, at block 802, receiving, at the search system 300, a query wrapper 340 from the user device 200 or another system (e.g., application system 150), and, at block 804, identifying a set of search records (e.g., entity records 400 and/or application state records 350).

At block 806, for each search record, the method 800 includes selecting, at the search system 300, display component data 454 based on the query wrapper 340 and metadata of the display component data 454 (e.g., image metadata 360, review metadata 370, or other metadata for display components 250). The selection of metadata 360, 370 may be based on a string or partial string match between the metadata 360, 370 and a search query 342 of the query wrapper 340. In some examples, the search system 300 modifies the display component data 454 to comply with rendering or formatting requirements.

In some implementations, the search system 300 selects display component data 454 (e.g., image data 362 and/or review data 372) for a first search record (e.g., one of the entity records 400 and/or the application state records 350) only from display component data 454 already associated with or stored in the first search record. In other implementations, the search system 300 identifies display component data and associates that display component data with a search record for purposes of display.

In some examples, the search system 300 generates result objects 450 populated with information from the entity records 400 and/or application state records 350 along with the identified display component data 454. The search results 440 may include a set of results objects 450. At block 808, the method 800 includes transmitting search results 440 from the search system 300 to the user device 200 or the other system, which can render the search results 440 as displayed search results 240.

Search results 440 including query-relevant images 262, 362 are generally more compelling to the user 10 and may cause an increase in click-through-rate for the search results 440. For example, in the case of a result object 450 of the search results 440 for a particular restaurant state, showing a cuisine image 262, 362 that is relevant to the search query 342 may be more relevant to the user 10 and may entice the user 10 to select the corresponding displayed result object 260 (e.g., over other displayed result objects 260). This feature can be monetized by an app developer in some scenarios. For example, the app developer may charge a business for including the feature in business' links (e.g., an up-front price and/or pay per click), because the feature may drive additional business.

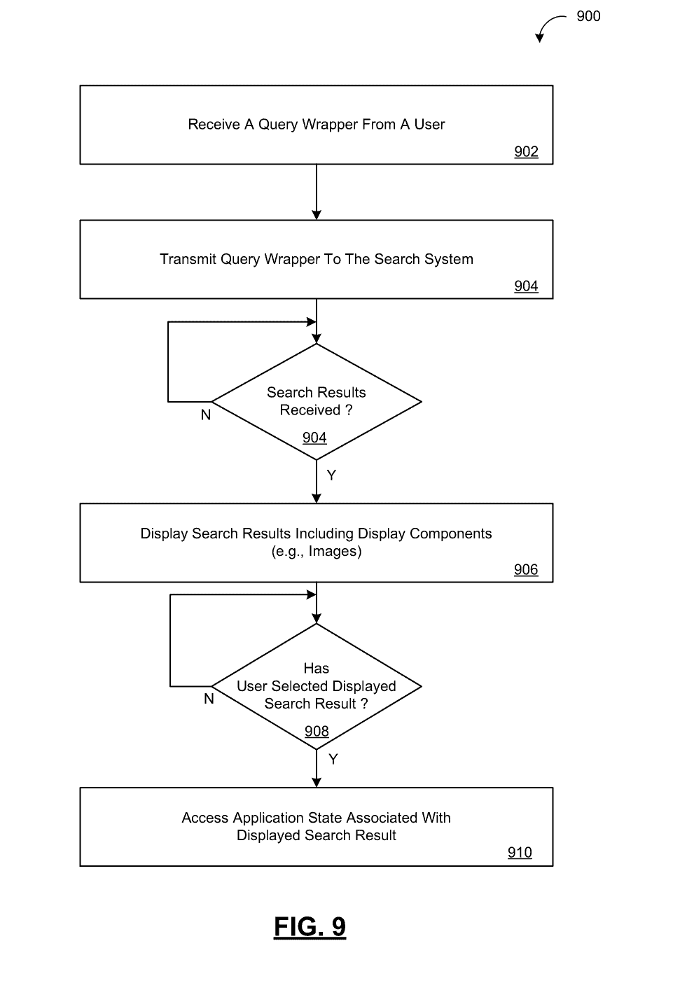

FIG. 9 provides an example arrangement of operations for a method 800 of retrieving search results 440 with display component data 454 customized for a query wrapper 340 (e.g., for a search query 342 of the query wrapper 340) and rendering displayed search results 240 having display components 250 bases on the customized display component data 454. At block 902, the method 900 includes receiving, at the user device 200, a query wrapper 340 (having a search query 342) from the user 10, and, at block 904, transmitting the query wrapper 340 to the search system 300. At block 904, the method 900 includes determining whether the user device 200 received search results 440 from the search system 300. When the user device 200 received search results 440 from the search system 300, at block 906, the method 900 includes rendering the search results 440 on the screen 202 of the user device 200 as displayed search results 240, where at least some of the search results 440 include a display component 250 having a user-selectable link 252 (associated with an application access mechanism 452). At block 908, the method 900 includes determining whether the user 10 has selected one of the displayed search results 440 (e.g., via a corresponding user-selectable link 252). When the user 10 selected one of the displayed search results 440, at block 910, the method includes launching the associated application 210 of the selected displayed search result 440 (e.g., the displayed result object 450) and setting the application 210 into a state specified by the associated access mechanism 452.

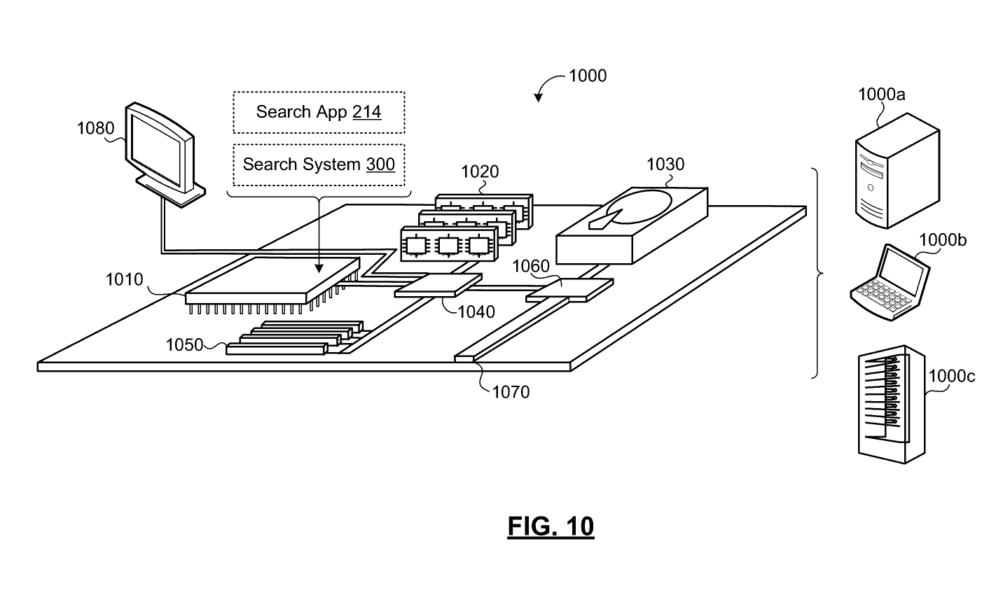

FIG. 10 is a schematic view of an example computing device 1000 that may be used to implement the systems and methods described in this document. The computing device 1000 is intended to represent various forms of digital computers, such as laptops, desktops, workstations, personal digital assistants, servers, blade servers, mainframes, and other appropriate computers. The components shown here, their connections and relationships, and their functions, are meant to be examples only, and are not meant to limit implementations of the inventions described and/or claimed in this document.

The computing device 1000 includes a processor 1010, memory 1020, a storage device 1030, a high-speed interface/controller 1040 connecting to the memory 1020 and high-speed expansion ports 1050, and a low-speed interface/controller 1060 connecting to low speed bus 1070 and storage device 1030. Each of the components 1010, 1020, 1030, 1040, 1050, and 1060 are interconnected using various buses and may be mounted on a common motherboard or in other manners as appropriate. The processor 1010 may correspond to the data processing hardware 220 of FIG. 2. The memory 1020 and the storage device 1030 may correspond to the memory hardware 230 of FIG. 2. The high-speed expansion ports 1050 may correspond to the network interface 222 of FIG. 2B.

The processor 1010 can process instructions for execution within the computing device 1000, including instructions stored in the memory 1020 or on the storage device 1030 to display graphical information for a graphical user interface (GUI) on an external input/output device, such as display 1080 coupled to high-speed interface 1040. In other implementations, multiple processors and/or multiple buses may be used, as appropriate, along with multiple memories and types of memory. Also, multiple computing devices 1000 may be connected, with each device providing portions of the necessary operations (e.g., as a server bank, a group of blade servers, or a multi-processor system).

The memory 1020 stores information non-transitorily within the computing device 1000. The memory 1020 may be a computer-readable medium such as volatile memory unit(s) or non-volatile memory unit(s). The memory 1020 may be physical devices used to store programs (e.g., sequences of instructions) or data (e.g., program state information) on a temporary or permanent basis for use by the computing device 1000. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM).

The storage device 1030 is capable of providing mass storage for the computing device 1000. In some implementations, the storage device 1030 is a computer-readable medium. In various different implementations, the storage device 1030 may be a floppy disk device, a hard disk device, an optical disk device, or a tape device, a flash memory or other similar solid-state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 1020, the storage device 1030, or memory on processor 1010.

The high-speed controller 1040 manages bandwidth-intensive operations for the computing device 1000, while the low-speed controller 1060 manages lower bandwidth-intensive operations. Such allocation of duties is exemplary only. In some implementations, the high-speed controller 1040 is coupled to the memory 1020, the display 1080 (e.g., through a graphics processor or accelerator), and to the high-speed expansion ports 1050, which may accept various expansion cards (not shown). In some implementations, the low-speed controller 1060 is coupled to the storage device 1030 and low-speed expansion port 1070. The low-speed expansion port 1070, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 1000 may be implemented in a number of different forms, as shown in the figure. For example, it may be implemented as a standard server 1000a or multiple times in a group of such servers 1000a, as a laptop computer 1000b, or as part of a rack server system 1000c.

Various implementations of the systems and techniques described here can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” and “computer-readable medium” refer to any computer program product, non-transitory computer-readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, the subject matter described in this specification can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more of them. The terms “data processing apparatus,” “computing device,” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as an application, program, software, software application, script, or code) can be written in any form of programming language, including compiled or interpreted languages, and it can be deployed in any form, including as a stand-alone program or as a module, component, subroutine, or another unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

One or more aspects of the disclosure can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specifics, these should not be construed as limitations on the scope of the disclosure or of what may be claimed, but rather as descriptions of features specific to particular implementations of the disclosure. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

A number of implementations have been described. Nevertheless, it will be understood that various modifications may be made without departing from the spirit and scope of the disclosure. Accordingly, other implementations are within the scope of the following claims. For example, the actions recited in the claims can be performed in a different order and still achieve desirable results.

What is claimed is:

1. A method comprising:
storing search records in a data store located in memory hardware, wherein each search record of the search records includes an access mechanism associated with a state of a mobile application;
receiving, at data processing hardware in communication with the memory hardware, a search query from a user device;
selecting, by the data processing hardware, a set of search records from the data store based on the search query;
generating search results corresponding to the set of search records;
for a first search record of the set of search records:
selecting one image from a plurality of images associated with the first search record based on relevance of metadata for the one image to the search query; and
including the one image in a first search result of the search results for display on the user device, wherein the first search result includes a first user-selectable link and a first access mechanism, and wherein the first user-selectable link is configured to invoke the first access mechanism in response to being actuated by a user of the user device, and wherein the first access mechanism is configured to, upon invocation, launch a corresponding mobile application to a corresponding state; and
transmitting the search results from the data processing hardware to the user device.

2. The method of claim 1, wherein:
the corresponding mobile application for the first access mechanism is a website edition of a first application; and
the corresponding state for the first access mechanism is a web page of the website edition.

3. The method of claim 2, wherein:
the first search record includes a second access mechanism configured to, upon invocation, open a native edition of the first application to a corresponding screen of the native edition.

4. The method of claim 1, wherein:
the corresponding mobile application for the first access mechanism is a native edition of a first application; and
the corresponding state for the first access mechanism is a screen of the native edition.

5. The method of claim 1, further comprising generating the metadata for the plurality of images associated with the first search record.

6. The method of claim 5, wherein the generating the metadata for the plurality of images associated with the first search record includes analyzing text associated with the plurality of images.

7. The method of claim 5, wherein the generating the metadata for the plurality of images associated with the first search record includes performing image recognition on the plurality of images.

8. The method of claim 5, wherein the generating the metadata for the plurality of images associated with the first search record is performed in response to the first search record being selected by the data processing hardware.

9. The method of claim 5, wherein the generating the metadata for the plurality of images associated with the first search record is performed prior to receiving the search query.

10. The method of claim 1, wherein:
the search query includes a text query and context data; and
the context data includes geolocation data of the user device.

11. The method of claim 1, wherein selecting the one image includes:
determining a candidate image from the plurality of images based on a best textual match between metadata for the candidate image and the search query;
calculating a confidence score for the candidate image indicative of a level of relevance of the metadata for the candidate image to the search query;
in response to the confidence score exceeding a threshold confidence score, selecting the candidate image as the one image; and
in response to the confidence score failing to exceed the threshold confidence score, selecting a default image of the plurality of images as the one image.

12. The method of claim 1, wherein selecting the one image includes:
determining a candidate image from the plurality of images based on a best textual match between metadata for the candidate image and the search query;
calculating a popularity score for the candidate image indicative of a level of popularity of the candidate image among end users based on at least one of (i) user ratings and (ii) click-through rate for the candidate image;
in response to the popularity score exceeding a threshold popularity score, selecting the candidate image as the one image; and
in response to the popularity score failing to exceed the threshold popularity score, selecting a default image of the plurality of images as the one image.

13. A search system comprising:
memory hardware configured to store (i) a set of instructions and (ii) a data store of search records, wherein each search record of the search records includes an access mechanism associated with a state of a mobile application; and
processing hardware electrically coupled to the memory hardware and configured to execute the set of instructions, wherein the set of instructions includes:
storing search records in a data store located in memory hardware, wherein each search record of the search records includes an access mechanism associated with a state of a mobile application;
receiving, at data processing hardware in communication with the memory hardware, a search query from a user device;
selecting, by the data processing hardware, a set of search records from the data store based on the search query;
generating search results corresponding to the set of search records;
for a first search record of the set of search records:
selecting one image from a plurality of images associated with the first search record based on relevance of metadata for the one image to the search query; and
including the one image in a first search result of the search results for display on the user device, wherein the first search result includes a first user-selectable link and a first access mechanism, and wherein the first user-selectable link is configured to invoke the first access mechanism in response to being actuated by a user of the user device, and wherein the first access mechanism is configured to, upon invocation, launch a corresponding mobile application to a corresponding state; and
transmitting the search results from the data processing hardware to the user device.

14. The search system of claim 13, wherein:
the corresponding mobile application for the first access mechanism is a website edition of a first application; and
the corresponding state for the first access mechanism is a web page of the website edition.

15. The search system of claim 14, wherein:
the first search record includes a second access mechanism configured to, upon invocation, open a native edition of the first application to a corresponding screen of the native edition.

16. The search system of claim 13, wherein:
the corresponding mobile application for the first access mechanism is a native edition of a first application; and
the corresponding state for the first access mechanism is a screen of the native edition.

17. The search system of claim 13, wherein the set of instructions includes generating the metadata for the plurality of images associated with the first search record.

18. The search system of claim 17, wherein the generating the metadata for the plurality of images associated with the first search record includes at least one of (i) analyzing text associated with the plurality of images and (ii) performing image recognition on the plurality of images.

19. The search system of claim 13, wherein selecting the one image includes:
determining a candidate image from the plurality of images based on a best textual match between metadata for the candidate image and the search query;
calculating a confidence score for the candidate image indicative of a level of relevance of the metadata for the candidate image to the search query;
in response to the confidence score exceeding a threshold confidence score, selecting the candidate image as the one image; and
in response to the confidence score failing to exceed the threshold confidence score, selecting a default image of the plurality of images as the one image.

20. The search system of claim 13, wherein selecting the one image includes:
determining a candidate image from the plurality of images based on a best textual match between metadata for the candidate image and the search query;
calculating a popularity score for the candidate image indicative of a level of popularity of the candidate image among end users based on at least one of (i) user ratings and (ii) click-through rate for the candidate image;
in response to the popularity score exceeding a threshold popularity score, selecting the candidate image as the one image; and
in response to the popularity score failing to exceed the threshold popularity score, selecting a default image of the plurality of images as the one image.
